(19) United States
(12) Patent Application Publication
(10) Pub. No.: US 2014/0269933 A1
(43) Pub. Date: Sep. 18, 2014

(54) VIDEO SYNCHRONIZATION TECHNIQUES USING PROJECTION

(71) Applicant: MAGNUM SEMICONDUCTOR, INC., Milpitas, CA (US)

(72) Inventor: Alexandros Tourapis, Milpitas, CA (US)

(73) Assignee: Magnum Semiconductor, Inc., Milpitas, CA (US)

(21) Appl. No.: 13/800,980

(22) Filed: Mar. 13, 2013

(51) Int. Cl. H04N 5/04

(52) U.S. Cl. CPC H04N 5/04
USPC 375/240.25; 348/500

(57) ABSTRACT

Examples of video synchronization techniques are described. Example synchronization techniques may utilize projection on convex spaces (POCS). The use of POCS may reduce complexity and may speed up synchronization in some examples. Projection on convex spaces generally involves projection (e.g. through summation, averaging, and/or quantization) of samples corresponding to a certain domain or dimension onto a particular axis or space. Weighted projection (e.g. averaging and/or summation) may also be used.

### TECHNICAL FIELD

Embodiments of the invention relate generally to video synchronization, and examples described include the use of projection onto convex spaces, which may reduce complexity and/or speed up synchronization.

### BACKGROUND

Synchronization of video sequences is used for a variety of applications including video quality analysis, frame/field loss detection, visualization, and security or copyright enforcement, among others. Synchronization techniques are generally used to identify corresponding pictures between two videos or video clips. By identifying corresponding pictures, the video sequences may then be compared by comparing the corresponding pictures. Comparison may be useful in assessing quality changes in the video and/or security or copyright violations, as mentioned above.

Typical synchronization procedures may proceed by selecting a number of not necessarily consecutive pictures in one video sequence and searching for those pictures in one or more other video sequences by performing a direct comparison of the selected pictures with all or a subset of pictures in the other sequence(s). The comparison may include a distortion computation using metrics such as the sum of absolute differences (SAD) or sum of square errors (SSE) with all pixels in a picture, or all pixels in a reduced resolution version of the picture.

Given N pictures selected in one sequence (e.g. seq_{—}0) to be compared with M pictures in another sequence (e.g. seq_j), where N<M, a typical synchronization procedure may try to locate a position (z) in seq_j where distortion between the reference N pictures and the N pictures starting from the position (z) is minimized. Using the SAD metric, this may involve a computation of distortion D where:

$$D = {\sum }_{i = 0}^{N - 1} {\sum }_{y = 0}^{height} {\sum }_{x = 1}^{width} \vert {I}_{0}^{i} ( x , y ) - {I}_{j}^{z + i} ( x , y ) \vert ,$$

with z starting from 0 and ending at M-N.

The distortion metric may be calculated for a variety of positions z, and position yielding the minimum distortion may be selected as an appropriate corresponding picture to a first selected picture of the other sequence.

### BRIEF DESCRIPTION OF THE DRAWINGS

FIG. 1 is a schematic illustration of a picture search for video synchronization in accordance with an example of the present invention.

FIG. 2 is a flowchart illustrating synchronization in accordance with an example of the present invention.

FIGS. 3A-F are a schematic illustration of projection techniques in accordance with examples of the present invention.

FIG. 4 is a flowchart of a method of synchronization using a multi-refinement approach in accordance with an embodiment of the present invention.

FIG. 5 is a schematic illustration of a decoder in accordance with an embodiment of the present invention.

### DETAILED DESCRIPTION

Certain details are set forth below to provide a sufficient understanding of embodiments of the invention. However, it will be clear to one skilled in the art that embodiments of the invention may be practiced without various of these particular details. In some instances, well-known video components, encoder or decoder components, circuits, control signals, timing protocols, and software operations have not been shown in detail in order to avoid unnecessarily obscuring the described embodiments of the invention.

Typical synchronization procedures described above may be complex and time consuming, particularly given the number of samples required to be processed and analyzed in some examples. Some techniques may be employed to speed up the search. For example, the number of pictures (e.g., frames or fields) may be subsampled, the resolution may be reduced, or the distortion computation may be terminated for a candidate z if the current distortion already exceeds a minimum even prior to summing over all samples. Alternatively, or in addition, the distortion may be assumed to monotonically increase, and the search may be terminated if the distortion reaches a threshold or if a sufficient local minimum distortion is located. These improvements, however, may still provide insufficient complexity reduction in some examples.

Accordingly, examples of the present invention may utilize projection on convex spaces (POCS). The use of POCS may reduce complexity and may speed up synchronization in some examples. Projection on convex spaces generally involves projection (e.g. through summation, averaging, and/or quantization) of samples corresponding to a certain domain or dimension onto a particular axis or space. Weighted projection (e.g. averaging and/or summation) may also be used.

FIG. 1 is a schematic illustration of a picture search for video synchronization in accordance with an example of the present invention. Generally a reference video, e.g. Seq 0, labeled 50 may be compared with one or more target videos 62, 64, 66. Within M pictures of each of the target videos 62, 64, 66, synchronization procedures generally try to locate a position within each one of the target sequences where distortion between the reference N pictures and the N pictures starting from the position in the target sequence is minimized.

FIG. 2 is a flowchart illustrating synchronization in accordance with an example of the present invention. In box 105, a reference and a target video clip are obtained. The reference and target video clips may each be all or a portion of a video. The video may be obtained in any suitable electronic format, and may be encoded with any encoding technique in some examples. The reference clip may, for example, be stored in a memory or other storage device. The target video clip may also be stored in a memory or other storage device, which may in some examples be the same memory or in other examples be a different memory device. The reference and target clips may be the clips to be compared in a quality assessment, or copyright evaluation, for example. In some examples, the target clip may be received from another device, e.g. received via a broadcast, the Internet, cellular network or the like while the reference clip may be stored in a memory device or other storage. Each of the reference and video clips may include one or more pictures in a sequence. Each picture may include a plurality of samples (in some examples, the samples may represent pixels). The samples may include intensity, color, and/or brightness values for a particular portion of the picture.

The reference and target video clip may accordingly be made accessible to hardware and/or software operable to (e.g. configured and/or programmed to) perform the procedure shown in FIG. 1. The hardware and/or software may include one or more processing unit(s), such as one or more processors, and executable instructions for performing synchronization techniques described herein. The executable instructions may be encoded on (e.g. programmed) a transitory or non-transitory computer readable medium such as a memory device.

In box 110, samples of the reference and target clips may be projected from at least one dimension onto a particular space. For example, a selected plurality of samples may be projected onto a particular space by averaging, summing, and/or quantizing the plurality of samples into a single representation of the projected samples. Samples from a particular dimension may be projected onto a certain space. Examples of dimensions include rows, columns, and diagonals, or portions thereof. Examples of spaces onto which the samples may be projected include a single value. So, for example, each row of sample values from the reference clip may be projected into a single value. In another example, each column of sample values from the reference clip may be projected into a single value. These examples yield a projection into a dimension of a single vector (e.g. one value for each row, column, diagonal or portion thereof). In other examples, a projection may also be made into a different dimension (e.g. two vectors). For example, each column of sample values from the reference clip may be projected into a single value and each row of sample values may be projected into a single value, resulting in two vectors.

Generally, a projection onto a particular space may occur for each picture (e.g., frame or field) in a target and/or reference clip. The projection of each picture of data onto the particular space may result in a collection of vectors in time, e.g. an array of projected data or multidimensional matrix. One or more vectors may be included in the array for each picture, as described above.

FIG. 3 is a schematic illustration of projection techniques in accordance with examples of the present invention. FIG. 3A illustrates a horizontal projection technique. All sample values of a row of a picture may be combined (e g summed, averaged, weighted summed) to provide a single value of a resulting search vector. The resulting search vector may have a size equal to a height of the picture of FIG. 3A. FIG. 3B illustrates a vertical projection technique. All sample values of a row of a picture may be combined (e.g. summed, averaged, weighted summed) to provide a single value of a resulting search vector. The resulting search vector may have a size equal to a width of the picture of FIG. 3B. Search vectors may be generated for each or selected pictures in the clip, resulting in a collection of search vectors representative of the clip, such as a multidimensional matrix.

Mathematically, the search vector resulting from projection of rows of samples (e.g. pixels) into respective single values, as shown in FIG. 3A, may be expressed as:

$$P ( j ) = {\sum }_{x = 1}^{width - 1} I ( x , j ) ;$$

where I is the intensity of the sample at the location x,j, P(j) represents the projected value and x is a location within the width of the picture.

A distortion metric may then be calculated mathematically as:

$$D = {\sum }_{i = 0}^{N} {\sum }_{y = 1}^{height} \vert {P}_{0}^{i} ( y ) - {P}_{j}^{z + i} ( y ) \vert ;$$

where P₀ represents the projected value from the reference clip and Pⱼ represents the projected value from the target clip. In other examples, the projected value from the reference clip may be subtracted from the projected value of the target clip.

Briefly, the distortion metric is calculated by summing the difference in the projected values over N pictures. The N pictures may be sequential and may or may not be consecutive. Different starting pictures z may be used, and multiple distortion metrics D calculated accordingly. The starting picture z yielding a minimum distortion metric may be selected as the synchronization point corresponding to a selected initial picture of the other clip.

In one embodiment, for the reference clip, a set of N search vectors may be generated, and for each of the target clips, a set of M search vectors may be generated, where M>N, as described above. For each set of M search vectors, (M−N+1) subsets may be provided by taking N vectors, for instance, in sequence. The starting picture corresponding to the subset having the minimum distortion metric relative to the set of N search vectors using may be identified as the synchronization point.

Note that the distortion metric provided above may result in a complexity reduction of about width times relative to the convention distortion metric described above that did not employ projection. The reduction in complexity may be approximate because in some examples operations may be performed for the projection process itself, which operations may be considerably lower in complexity than operations required for the comparison (e.g. search) process used to select a synchronization picture.

Other projections may also be performed in box 110 of FIG. 2. For example, multiple lines (e.g. rows and/or columns) of a picture may be projected into a single value. The multiple lines may or may not be adjacent lines. In one example, data from four consecutive lines may be projected onto a same value. Using this projection to calculate the projected values and then the distortion metric may achieve approximately a 4× width reduction in complexity (and accordingly speed up in some examples) of the search for the synchronization point.

In other examples, projection may be used into multiple spaces (e.g. axes). For example, sample values may be projected both horizontally and vertically, resulting in two vectors of size width and height of a picture, respectively. FIG. 3C illustrates an example of projecting both horizontally and vertically. Mathematically, the projection may yield two vectors Pᵥ and Pₕ as follows:

$${P}_{v} ( j ) = {\sum }_{x = 1}^{width - 1} I ( x , j ) ; and {P}_{h} ( i ) = {\sum }_{y = 1}^{height - 1} I ( i , y ) ;$$

for j going from 1 to a height of the picture and I going from 1 to a width of the picture. These two vectors Pᵥ and Pₕ may also be merged into a single vector of size height+width. In this manner, examples of the present invention may project sample values onto multiple spaces (e.g. axes). Vectors may be generated for each picture, or selected pictures, in a clip, resulting in an array of search vectors, e.g. a multidimensional matrix.

In other examples, a picture may be segmented into multiple segments and projection of each segment may be performed. The segments need not be the same size, but may be in some examples, and may be overlapping or non-overlapping. Segments may be defined using a group of rows, a group of columns, or based on a diagonal split. Sample values (e.g. pixels) of each segment may be projected using any projection to generate search vectors. For example, the projections may be horizontal, vertical, diagonal, or combinations thereof for each segment. FIG. 3D illustrates an example of projection using two segments, with each segment 305 and 306 including a portion of the rows of the picture. Projection yields two search vectors per picture in the example of FIG. 3D—one corresponding to each segment 305 and 306. FIG. 3E illustrates an example of projection using four segments, with each segment 315-318 including a portion of the rows of the picture. Projection yields four search vectors per picture in the example of FIG. 3E—one corresponding to each segment 315-318. FIG. 3F illustrates an example of projection using two segments defined diagonally. Each segment 325 and 326 includes respective portions of the picture. Projection yields two search vectors, one corresponding to each segment 325, 326. The projection techniques in FIG. 3D-3F using segments are all shown as projecting horizontally by combining the samples in the rows of each segment. However, projection may instead be performed vertically, diagonally, in multiple directions, or combinations thereof. Multiple projection methods per segment may be used in some examples to provide multiple search vectors per segment.

Referring again to FIG. 2, the same projection technique used on the reference clip in box 110 may be used on the target clip, resulting in a similar output (e.g. multidimensional matrix including vector or vectors per picture). The vector or vectors may be referred to as search vectors herein. The projected values (e.g. search vectors) may be compared in box 115 to select a synchronization point. The comparison may include calculating a distortion metric between the search vectors included in the array of search vectors (e.g. multidimensional matrix) representing the target and reference clips. Recall the example provided above regarding the projection of rows of samples to a search vector. Mathematically, the search vector resulting from projection of rows of samples (e.g. pixels) into respective single values, as shown in FIG. 3A, may be expressed as:

$$P ( j ) = {\sum }_{x = 1}^{width - 1} I ( x , j ) ;$$

where I is the intensity of the sample at the location x,j, P(j) represents the projected value and x is a location within the width of the picture.

A distortion metric may then be calculated mathematically as:

$$D = {\sum }_{i = 0}^{N} {\sum }_{y = 1}^{height} \vert {P}_{0}^{i} ( y ) - {P}_{j}^{z + i} ( y ) \vert ;$$

where P₀ represents the projected value form the target clip and Pⱼ represents the projected value from the target clip. The synchronization point may be selected by identifying a starting picture in the reference or target clip that results in a minimum distortion metric when compared with the corresponding picture in the other one of the reference or target clip.

Accordingly, in box 115 of FIG. 2, the array of search vectors for pictures in the reference and target clips may be compared to identify corresponding pictures having a smallest distortion metric (e.g. difference). Generally, a difference between the search vectors in arrays of search vectors representing pictures between the target and reference clips may be calculated. The calculation may be repeated for different sequences in comparison with selected pictures of the target clip to identify a best synchronization point (e.g. identify a picture in a target clip that corresponds with a picture in the reference clip). For example, a first comparison may be made utilizing a first search vector (e.g. for a first picture) in a target clip corresponding to a first search vector in a reference clip. The comparison may include a difference between the search vectors and differences between corresponding subsequent search vectors in the arrays of search vectors representing the clips. Another comparison may be made utilizing a different search vector (e.g. for a second picture) in a target clip corresponding to the first search vector in a reference clip. The comparison may include a difference between the different search vector and the first search vector and differences between corresponding subsequent search vectors in the arrays of search vectors representing the clips. Generally, in box 115 of FIG. 2, an array of search vectors (e.g. multidimensional matrix) for the target clip may be traversed, and all or selected sub-vectors (e.g. individual search vectors corresponding to selected pictures) may be compared with corresponding sub-vectors in the array of search vectors (e.g. multidimensional matrix) for the reference clip. The comparison may be made using different starting points and/or selection of sub-vectors in the array of search vectors for the target clip, and a starting position or other selected sub-vector associated with a minimum distortion metric may be selected as a synchronization point.

In embodiments directed to interlaced sources, comparisons of various target clips to a reference clip may further identify field misalignments. In some instances, vectors generated from interlaced sources may be generated in frame mode, field mode, or a combination thereof, thereby allowing for selection of the more efficient mode for any given source.

Accordingly, in examples of the present invention a synchronization point may be identified by a comparison of search vectors from the array of search vectors representing the target and reference clips, as described with reference to FIGS. 2 and 3. In some examples, however, the projection method used, e.g. in box 110 of FIG. 2, may fail to generate search vectors that are usable to identify a synchronization point. Accordingly, in some examples, a multi-refinement approach may be used.

FIG. 4 is a flowchart of a method of synchronization using a multi-refinement approach in accordance with an embodiment of the present invention. In box 405, a reference and target video clip are obtained. Box 405 may be analogous to box 105 of FIG. 2. Any number of target clips may be used, and the target and reference clips may be stored in any electronic storage, transient or non-transient, and may be received from any source, e.g. over the Internet or other network, from storage, etc.

In box 410, samples of the reference and target clips may be projected from at least one dimension onto a particular space in accordance with any of the projection methods described herein. Accordingly, projection may occur horizontally, vertically, diagonally, or combinations thereof. Projection may occur along multiple dimensions, and may occur in segments of pictures, as has been described above. In this manner, an array of search vectors (e.g. a multidimensional matrix) for the reference and target clips may be generated in box 410. The projection methods described above with reference to FIG. 2 and box 110 may be used to implement box 410. As described further herein, however, generally a lower complexity projection method may be used in box 410 than in other projections of FIG. 4. Lower complexity refers generally to a projection requiring less computation (e.g. a projection onto one axis is a lower complexity than a projection onto multiple axes, a projection using a single segment per picture is a lower complexity than a projection using multiple segments per picture, etc.).

In box 415, the search vectors of the target and reference clips may be compared as has been described above with reference to box 115 of FIG. 2. For example, the difference between search vectors in a sequence of pictures in the reference clip and search vectors in a variety of sequences of pictures in the target clip (e.g. using different starting pictures) may be calculated. The difference may include or form part of a distortion metric calculation.

In box 420, possible matches may be identified. The possible matches may be a selected number, e.g. R₀, of best possible candidates for a synchronization point. Accordingly, a selected number of pictures or sequences may be identified in box 420 which generate the lowest distortion metrics and/or smallest difference between the search metrics of the pictures and the reference pictures. For these candidates, further projection may be performed.

In box 425, another projection technique, different from the projection technique used in box 410, may be used on the reference and target video clips to generate different search vectors. In one example, the projection techniques are of a same or similar complexity in boxes 410 and 425 (e.g. projection horizontally in box 410 and projection vertically in box 425). In another example, the projection technique used in box 425 may have a higher complexity than the projection technique used in box 410. In some examples, a lower resolution version of the reference and target video clips may be used to generate search vectors in box 410 while a higher resolution version of the reference and target video clips may be used to generate search vectors in box 425.

Accordingly, in box 425 new search vectors may be generated for the reference and target video clips using a different projection technique than used in box 410. The search vectors in box 425 may be generated for only those candidates identified in box 420, which may reduce the amount of computation required in box 425. In box 425 the projection is performed to generate new search vectors, and the search vectors may be compared to identify a synchronization point in box 430. In some examples, a synchronization point may not be identified in box 430, but rather a further set of best possible candidates may be identified, generally a fewer number than identified in box 420, and a further projection technique may be performed by repeating boxes 425 and 430.

In some examples, the synchronization point may be identified in box 430 when the comparison (e.g. distortion metric) is lower than a particular threshold than the comparison for other candidates. The synchronization point may then be selected and the search process may be halted. In some examples, another projection may nonetheless be performed (e.g. by repeating box 425 with a different projection technique) and the synchronization point may be confirmed if the same candidate (e.g. search vector corresponding with a selected first picture) is again indicated as creating the smallest distortion. Accordingly, the search process may be halted when the same candidate is identified as a synchronization point following multiple projection techniques and comparisons. In other examples, the search process may be halted when a candidate is identified yielding a distortion metric less than a first threshold following a first comparison and a distortion metric less than a second threshold (which may be a lower threshold) following a second comparison using a different projection technique. In this manner, synchronization may be achieved while reducing overall complexity of the synchronization procedure in some examples.

Once a synchronization point has been identified, any procedures relying on synchronization may be performed (e.g. quality comparisons, copyright or other security validations, etc.). The synchronization point may be a single picture in the target clip identified as corresponding with a picture in the reference clip, or the synchronization point may be a sequence of pictures in the target clip identified as corresponding with a sequence of pictures in the reference clip.

FIG. 5 is a schematic illustration of a decoder in accordance with an embodiment of the present invention. The decoder 500 may be used to implement the synchronization techniques described herein. The decoder 500 may include a decode unit 510 and a synchronization unit 515. The decoder 500 may receive an encoded bit stream, which may be encoded using any encoding methodology, including but not limited to MPEG standards and/or H.264. The decode unit 510 may decode the encoded bit stream in accordance with the encoding standard with which it had been encoded. The synchronization unit 515 may receive the decoded bitstream from the decode unit 510, and the decoded bitstream, or portions of the decoded bitstream may be used as the target clip described herein. A reference clip may be accessible to the synchronization unit 515 from a memory, network connection, or other electronic storage mechanism. The synchronization unit 515 may perform the synchronization techniques (including projection techniques and comparisons) described herein. Both the decode unit 510 and synchronization unit 515 may be implemented in hardware, software, or combinations thereof. The synchronization unit 515, for example, may be implemented using one or more processing unit(s), such as a processor, and transitory or non-transitory computer readable storage encoded with instructions for performing any of the synchronization techniques described herein. The synchronization unit 515, for example, may be implemented all or in part using hardware (e.g. logic, ASIC, etc.) arranged to perform the all or portions of any of the synchronization techniques described herein (e.g. a dedicated hardware unit may be used, for example, to perform comparisons between search vectors as described herein).

Synchronization information (e.g. synchronization point, identity of one or more corresponding pictures in the target and reference clips) may accordingly be provided to downstream units (not shown) in FIG. 5 that may utilize the synchronization information to perform accurate comparisons of the target and reference clips (e.g. confirm ownership by verifying copyright information embedded in the target and reference clips, assess quality as between the target and reference clips, etc.). The synchronization information may allow for accurate comparisons between the target and reference clips.

From the foregoing it will be appreciated that, although specific embodiments of the invention have been described herein for purposes of illustration, various modifications may be made without deviating from the spirit and scope of the invention.

What is claimed is:

1. A method for synchronizing a target and reference video clip, the method comprising:
projecting samples of the reference clip from at least one dimension onto a particular space to provide at least one search vector representative of the reference clip;
projecting samples of the target clip from the at least one dimension onto the particular space to provide at least one search vector representative of the target clip; and
comparing the at least one search vector representative of the reference clip and the at least one search vector representative of the target clip to select a synchronization point.

2. The method of claim 1, wherein said projecting samples of the reference clip comprises projecting samples of the reference clip to provide a multidimensional matrix representative of the reference clip, wherein the multidimensional matrix comprises a plurality of search vectors, each of the plurality of search vectors corresponding to at least one picture of the reference clip.

3. The method of claim 1, wherein said projecting samples of the target clip comprises projecting samples of the target clip to provide a multidimensional matrix representative of the target clip, wherein the multidimensional matrix comprises a plurality of search vectors, each of the plurality of search vectors corresponding to at least one picture of the target clip.

4. The method of claim 1, wherein said projecting samples of the reference clip from at least one dimension onto a particular space comprises combining the samples from a row of a picture of the reference clip into a single value.

5. The method of claim 1, wherein said projecting samples of the reference clip from at least one dimension onto a particular space comprises combining the samples from a column of a picture of the reference clip into a single value.

6. The method of claim 1, wherein said samples correspond to pixels of a picture of the reference clip or target clip, respectively.

7. The method of claim 1, wherein said projecting samples of the reference clip from at least one dimension onto a particular space comprises combining the samples from a row of a picture of the reference clip into a single value and combining the samples from a column of the picture of the reference clip into a single value.

8. The method of claim 1, wherein said comparing comprises calculating a distortion metric using the at least one search vector representative of the reference clip and the at least one search vector representative of the target clip.

9. The method of claim 8, wherein said calculating a distortion metric comprises traversing an array of search vectors including the at least one search vector representative of the reference clip and comparing selected search vectors in the array of search vectors representative of the reference clip with corresponding selected search vectors in an array of search vectors representative of the target clip.

10. A method of synchronizing at least one target clip with a reference clip, the method comprising:
projecting samples of the reference clip from at least one dimension onto a particular space;
projecting samples of the at least one target clip from the at least one dimension onto the particular space;
comparing the projected samples from the reference clip to the projected samples of from the at least one target clip using a plurality of different starting pictures; and
identifying ones of the different starting pictures providing a minimum difference to the projected samples from the reference clip.

11. The method of claim 10, further comprising performing a different projection on the samples of the reference clip and the at least one target clip to provide further search vectors; and
comparing the further search vectors at locations corresponding to the ones of the different starting pictures to identify a synchronization point.

12. The method of claim 11, further comprising comparing a quality of the reference and target clips using the synchronization point.

13. The method of claim 11, further comprising verifying a copyright status of the target clip using the synchronization point.

14. The method of claim 11, wherein said projecting samples of the reference clip from at least one dimension onto a particular space comprises using a lower complexity projection technique than the different projection.

15. The method of claim 11, wherein said projecting samples of the reference clip from at least one dimension onto a particular space comprises combining samples in each row of a picture of the reference clip to provide a single value in a search vector, and wherein said different projection comprises combining samples in each row of the picture to yield a respective value for a search vector and combining samples in each column of the picture to yield a respective value for another search vector.

16. The method of claim 11, wherein said projecting samples of the reference clip comprises segmenting a picture of the reference clip into multiple segments and providing a search vector for each of the multiple segments.

17. The method of claim 11, wherein said comparing the further search vectors at locations corresponding to the ones of the different starting pictures to identify a synchronization point comprises identifying the synchronization point corresponding to a starting picture yielding a distortion metric having a value below a threshold.

18. A decoder comprising:
a decoding unit configured to receive an encoded bitstream and decode the encoded bitstream to provide a decoded bitstream;
a synchronization unit configured to receive the decoded bitstream and a reference clip, the synchronization unit configured to:
project samples of the reference clip from at least one dimension onto a particular space to provide at least one search vector representative of the reference clip;
projecting samples of the decoded bitstream from the at least one dimension onto the particular space to provide at least one search vector representative of the decoded bitstream; and
compare the at least one search vector representative of the reference clip and the at least one search vector representative of the decoded bitstream to select a synchronization point.

19. The decoder of claim 18, wherein the encoded bitstream is received over a broadcast network.

20. The decoder of claim 18, wherein the encoded bitstream is received over the Internet.

21. The decoder of claim 18, wherein the reference clip is stored in an electronic storage medium accessible to the decoder.

22. The decoder of claim 18, wherein the synchronization unit comprises at least one processing unit and a computer readable medium encoded with instructions executable by the at least one processing unit.

23. The decoder of claim 18, wherein the synchronization unit is further configured to provide synchronization information including the synchronization point to a downstream unit configured to conduct a comparison of the reference clip and decoded bitstream.
